(19) United States
(12) Patent Application Publication
(10) Pub. No.: US 2020/0183052 A1
(43) Pub. Date: Jun. 11, 2020

(54) CONDUCTIVE AND DIFFUSIVE ANTIREFLECTION SURFACE

(71) Applicant: Commissariat A L'Energie Atomique et aux Energies Alternatives, Paris (FR)

(72) Inventors: Helga SZAMBOLICS, Grenoble Cedex (FR); Cedric DUCROS, Grenoble Cedex (FR); Nicolas DUNOYER, Grenoble Cedex (FR); Emmanuel OLLIER, Grenoble Cedex (FR)

(73) Assignee: Commissariat A L'Energie Atomique et aux Energies Alternatives, Paris (FR)

(21) Appl. No.: 16/706,907

(22) Filed: Dec. 9, 2019

(30) Foreign Application Priority Data
Dec. 10, 2018 (FR) 18 72614

(51) Int. Cl. G02B 1/11; G02B 27/14; C03C 17/36

(52) U.S. Cl. CPC G02B 1/11; C03C 2204/08; C03C 17/3671; G02B 27/144

(57) ABSTRACT

The invention relates to a scattering and conductive anti-reflection surface, comprising a continuous electrically conductive material of variable thickness deposited on a textured surface so as to render the assembly anti-reflective and scattering.

The invention relates to scattering and conductive anti-reflective surfaces, and in particular surfaces made on a substrate and comprising a transparent conductive electrode.

Such surfaces are commonly found, for example, in photovoltaic optical components, photodetectors, devices to generate light from electrical excitation, and electrochromic devices. The transparent electrode is used for its electrical conduction properties, and the transparent substrate for mechanical strength and protection of the device.

The transparent substrate is generally made of glass, such as borosilicate or soda-lime glass, or of flexible polymer-type substrates. The transparent electrode is frequently made of transparent conductive oxide such as doped indium oxide, doped zinc oxide, or doped tin oxide.

Refractive index transitions between the different components of an optical device cause light reflections, which reduce the performance of the device and change its appearance.

A known solution to reduce reflection is to texture the interfaces between the different components. Texturing the surface of the substrate on which the electrode is formed reduces reflection at the interface between the electrode and the substrate.

By texturing the other surface of the substrate, reflection at the interface between the substrate and the incident environment is reduced.

A method for texturing one surface of the glass forming an glass/air interface is notably described in the document “Optimal Moth Eye Nanostructure Array on Transparent Glass Towards Broadband Antireflection”, published by Seungmuk Ji et al, in the journal ACS Applied Material Interfaces, in 2013, 5, pages 10731-10737. According to this method, the glass is masked according to a pattern and then partially etched according to this pattern in order to obtain a regular texture.

The document ‘Antireflective grassy surface on glass substrates with self-masked dry etching’, published by M. Song et al, in Nanoscale Research Letters 2013, 8:505, describes a method for texturing one surface of the glass to form a glass/air interface. This method is based on dry etching, namely reactive ion etching in a CF₄/O₂ mixture, and simplifies the fabrication method by avoiding the use of masks.

The document ‘SF6/Ar Plasma textured periodic glass surface morphologies with high transmittance and haze ratio of ITO:ZR films for amorphous silicon thin film solar cells’ by Hussain et al, published in Vacuum 117 pages 91 to 97, describes a method for texturing a glass sheet to obtain a scattering by TCO deposited on the formed texture. This document proposes a dry etching method through an etching mask.

The use of these texturing methods is insufficient to adequately reduce the specular reflection of the environment and the alteration of the saturation of the surface colour. Thus, specular reflection reflects the image of the environment and can create glare effects in the event of specular reflection from an intense external light source. The discretion of the surface and the comfort for the surrounding observers are thus altered.

The invention aims to solve one or more of these disadvantages. The invention thus relates to a scattering and conductive anti-reflective surface, as defined in the accompanying claims.

The invention further relates to an optical device as defined in the accompanying claims.

The invention further relates to a method for fabricating a scattering and conductive anti-reflective surface, as defined in the accompanying claims.

The invention further relates to variants of the dependent claims. The skilled person will understand that each of the features of the description or of a dependent claim can be combined independently with the features of an independent claim, without constituting an intermediate generalization.

Other features and advantages of the invention will emerge clearly from the description provided below, by way of indication and without limitation, with reference to the accompanying drawings, in which:

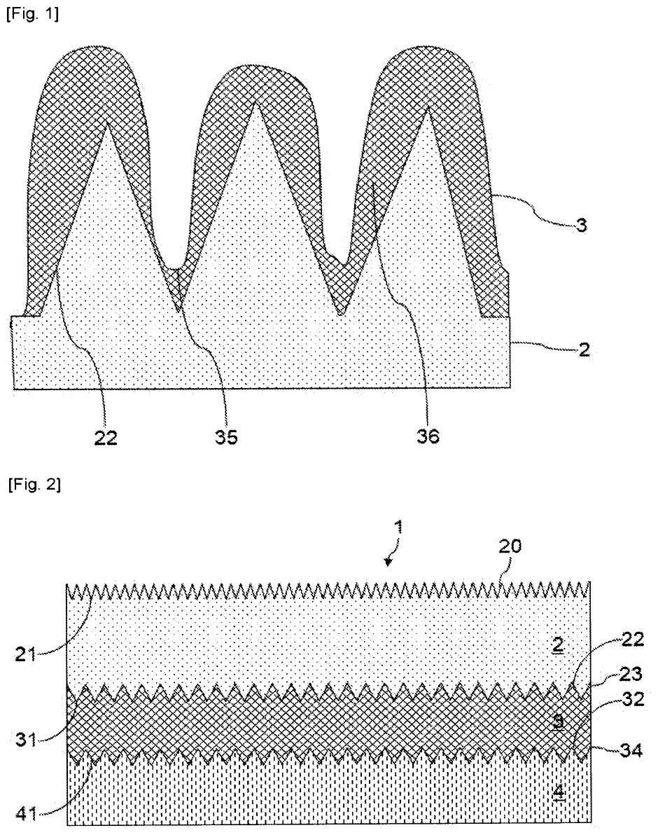

FIG. 1 is a schematic cross-sectional view of an example of a scattering and conductive anti-reflective surface according to an embodiment of the invention;

FIG. 2 represents an example of a structure using the surface illustrated in FIG. 1, in a device for absorbing or emitting light;

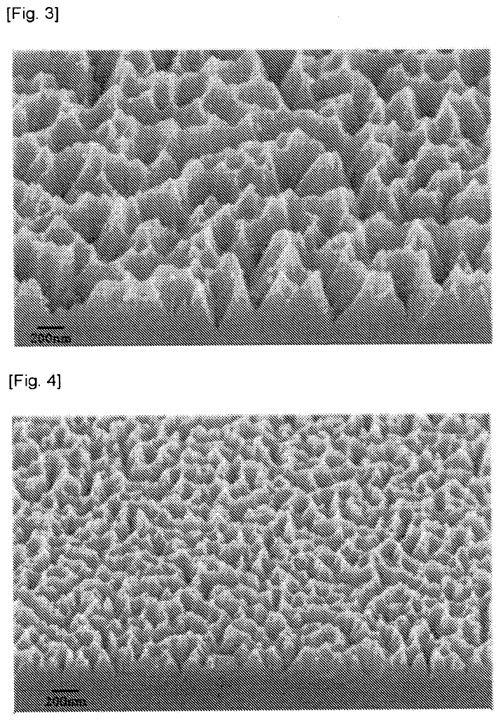

FIG. 3,

FIG. 4 and

FIG. 5 are scanning electron micrographs of textured glass surfaces according to different fabrication methods;

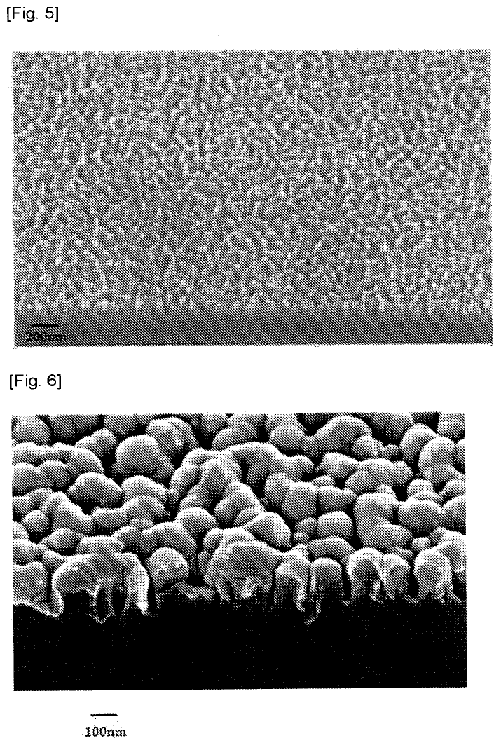

FIG. 6 is a scanning electron micrograph of the anti-reflective and conductive surface according to the invention and whose structure is illustrated in FIG. 1;

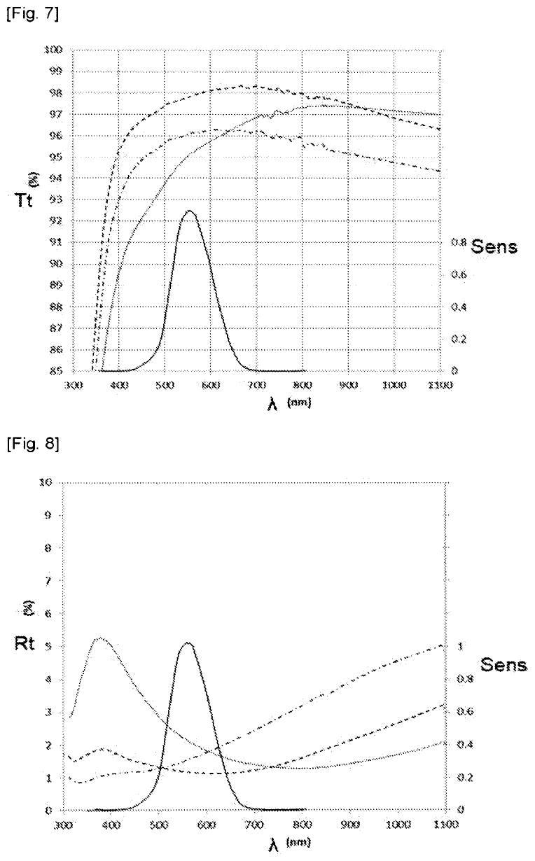

FIG. 7 and

FIG. 8 and

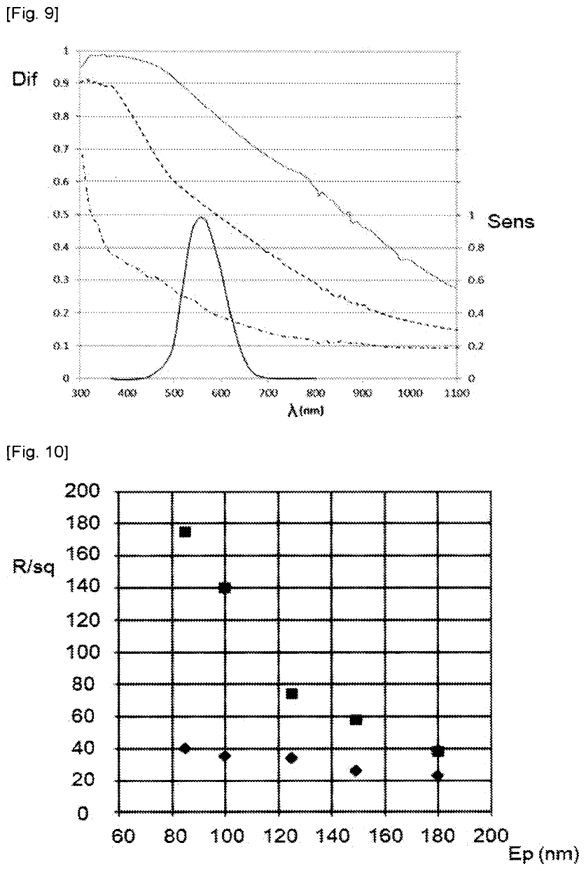

FIG. 9 are diagrams illustrating different optical parameters of the textured glass surfaces illustrated in FIGS. 3 to 5;

FIG. 10 is a diagram comparing the influence of the thickness of an electrode film on its sheet resistance (R/sq), for a structure according to the invention and a structure of the prior art;

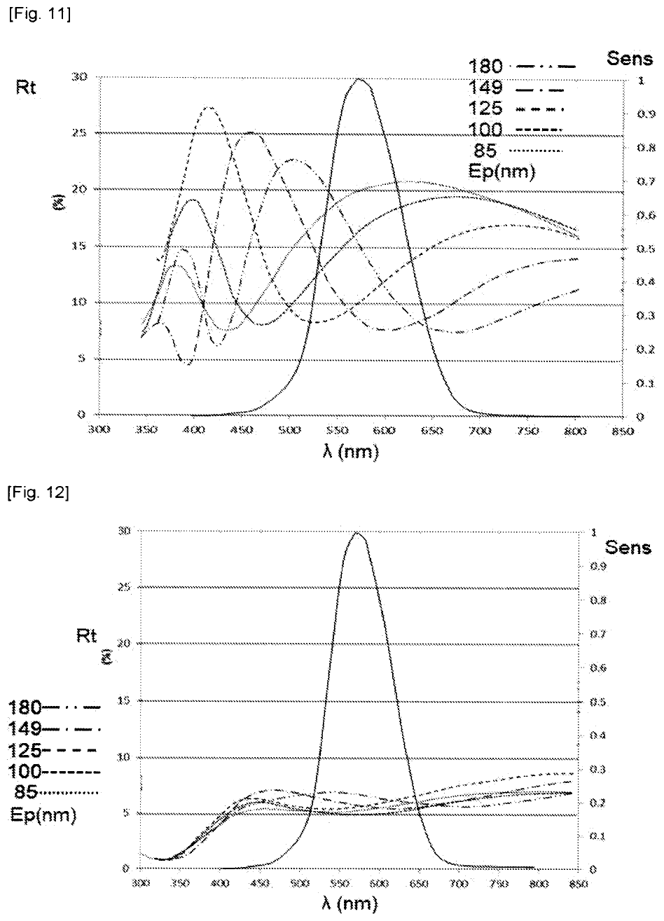

FIG. 11 is a diagram of the reflection spectra on an electrode deposited on a substrate of the prior art, as a function of the thickness of this electrode;

FIG. 12 is a diagram of the optical reflection spectra on an electrode deposited on a substrate for a surface according to the invention, as a function of the thickness of this electrode;

FIG. 13 is a diagram of diffuse optical reflection for different thicknesses of an electrode deposited on a textured substrate for a surface according to the invention, as a function of the wavelength and thickness of the electrode;

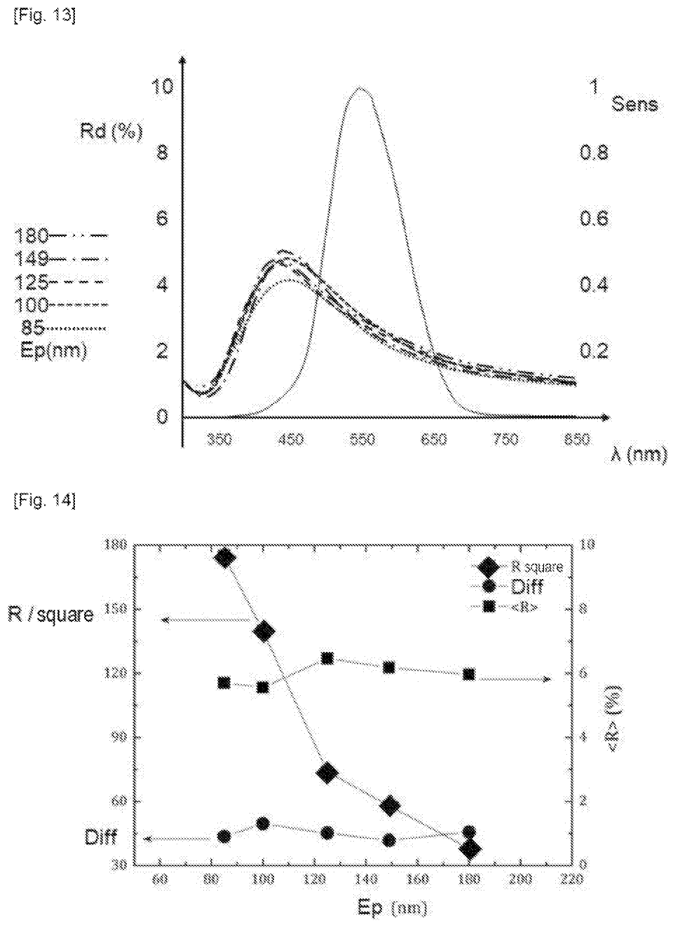

FIG. 14 is a diagram illustrating the evolution of different optical and electrical parameters (<R>average reflection over the range 400-800 nm, R/square sheet resistance, and Diff diffuse reflection rate) as a function of the thickness of an electrode on a textured substrate, for a surface according to the invention.

A textured surface is defined as a surface with a roughness or relief relative to a smooth geometric shape.

A scattering and conductive anti-reflective surface illustrated in FIG. 1 can be used alone or integrated into a device. In case an electrical function is required, the anti-reflective surface can act as an electrical contact.

FIG. 2 is a schematic cross-sectional view of an example of integration of the scattering and conductive anti-reflective surface into a device 1 according to an embodiment of the invention. The device 1 comprises a glass substrate 2, a transparent electrode 3 and an active optical device layer 4 consisting of one or more layers. The transparent electrode 3 is positioned in contact between the glass substrate 2 and the active optical device layer 4.

The substrate 2 is for example made of borosilicate glass or soda-lime glass. The glass substrate 2 has an outer surface 21 in contact with air at an interface 20, and an inner surface 22 in contact with the electrode 3 at an interface 23. The surfaces 21 and 22 can be opposed and textured.

The transparent electrode 3 is continuous, to be able to transport electrical charges. The electrode 3 is for example made of a conductive oxide such as doped zinc oxide, doped tin oxide, or doped indium oxide. The transparent electrode can also be made of an alloy of these materials, for example ITZO. At the interface 23, the transparent electrode 3 has a surface 31 in contact with the surface 22 and of complementary shape. The transparent electrode 3 also has a surface 32, opposite to surface 31. This surface 32 is in contact with the active optical device layer 4 at an interface 34.

The surface 21 has an appropriate texturing that allows it to obtain an anti-reflective function whose residual reflection is mainly diffuse. Preferably, the texturing of the surface 21 is configured so that the proportion of diffuse reflection to total reflection is at least 20% and can reach more than 80% (FIG. 9).

The texturing of the surface 21 will be advantageously configured so that the optical reflection at the interface 20, weighted by human spectral sensitivity, at this surface 21, is less than 3%.

The surface 22 has advantageously an appropriate texturing that allows it to limit total reflection and increase optical transmission through the superposition of the substrate 2 and of the transparent electrode 3 with a high proportion of scattering. Therefore, scattering the reflected and transmitted light avoids the reflection of the environment (anti-reflection effect, improvement of colours thanks to the reduction of the reflection of ambient light on the surface), limits the glare effects linked to the specular reflection of an intense light source, improves the efficiency of a potential device for absorbing or emitting light. Advantageously, the texturing of the surface 22 is configured so that the proportion of diffuse reflection in the total optical reflection through the superposition of the substrate 2 and the electrode 3 is controllable in a wide range.

Advantageously, the texturing of the surface 22 is configured so that the optical reflection of the superposition of the substrate 2 and the electrode 3 is less than 6.5%.

The texturing of the surface 22 is especially used to facilitate the formation of a textured electrode 3 with properties detailed hereinbelow.

According to the invention, the surface 32 (and thus the contact interface 34 between the transparent electrode 3 and a medium 4) is textured, so that the light reflected or transmitted to this interface is respectively minimized or maximized and, in this fashion, diffused.

Advantageously, the textures of the surfaces of the media 1, 2, 3 are configured so that the optical reflection of light from the media 1 is less than 6.5%.

According to the formation mode chosen for the transparent electrode 3, the geometry and the texturing of the surface 32 (and therefore of the contact interface 34) may depend on the geometry and on the texturing of the surface 22.

In particular, for a method of depositing the transparent electrode 3 on the surface 22 with certain parameters, it will be possible to partially reproduce reliefs of 30 the texturing of the surface 32 superposed on the reliefs of the texturing of the surface 22.

In order to promote the reproduction of the reliefs of the surface 22 at the surface 32 (and therefore at the interface 34) and thus to preserve a certain texturing of the surface 34, even with a reduced height level of the reliefs, the electrode 3 can be expected to have a limited thickness relative to the depth of the texturing of the surface 22, preferably limited to the value of its depth. A high aspect ratio (height-to-width ratio of the reliefs) of the surface 22 helps to preserve the texturing of the interface 34. This aspect ratio must therefore be increased for an electrode 3 of greater thickness.

In order to promote the electrical properties of the electrode 3, it is advantageously thick enough to ensure its electrical continuity around structures. In order to promote the electrical continuity of the electrode 3, it has advantageously a thickness at least equal to 25% of the texturing depth of the surface 22.

Advantageously, to favour the proportion of scattering in the reflection or transmission at the interface 34, on the one hand, and at the interface 23, on the other, the thickness of the electrode 3 is advantageously non-uniform: the thickness of the electrode 3 at the bottom of the texturing of the surface 22 is lower than its thickness at the peaks of the texturing of the surface 22.

FIGS. 3 to 6 are same-scale scanning electron micrographs of the surface of glass substrates that have undergone texturing by plasma etching processes with different parameters, according to procedures detailed below.

Such substrates have made it possible to carry out a number of experiments to determine their influence on the optical or electrical parameters of a scattering and conductive anti-reflective substrate. The results of various experiments are notably illustrated in the diagrams in FIGS. 7 to 14.

A common point between the reliefs obtained by the different texturing parameters of the substrate, as illustrated in FIGS. 3 to 5, is that, unlike the structures presented in the prior art, the texturing of the substrate obtained is in the form of a disordered set of interconnected walls, of triangular cross-section. These walls extend over distances ranging from 0.2 to a few micrometres. The average width and heights of the structures obtained with the three etching conditions are listed in Table 1. Texturing width and height are interdependent and linked to the etching parameters. These geometric parameters favour light scattering. The form factor is always greater than 1. The surface of the etched glass has no residual flat surfaces, which favours low reflection.

For the example illustrated in FIG. 3, the average pitch between the textured relief patterns is 300 nm. The height of the relief patterns is between 330 and 600 nanometres, with an estimated average of 465 nm. The height to pitch ratio of the relief patterns is equal to 1.55.

For the example illustrated in FIG. 4, the average pitch between the relief patterns is 160 nm. The height of the relief patterns ranges from 170 to 340 nanometres, with an estimated average of 255 nm. The height to pitch ratio of the relief patterns is equal to 1.59.

For the example illustrated in FIG. 5, the average pitch between the relief patterns is 80 nm. The height of the relief patterns is between 100 and 200 nanometres, with an estimated average of 150 nm. The height to pitch ratio of the relief patterns is equal to 1.87.

For these three texturing examples, FIG. 7 illustrates the total transmission rate Tt, FIG. 8 illustrates the total reflection rate Rt, and FIG. 9 illustrates the ratio Dif between the diffuse reflection and the total reflection of a glass substrate 2 textured on both surfaces. The dotted line curve corresponds to the example in FIG. 3, the dashed line curve corresponds to the example in FIG. 4 and the dash-dotted line corresponds to the example in FIG. 5. In each of the diagrams in FIGS. 7 to 9, the solid line curve corresponds to the human spectral sensitivity Sens, according to the function V(λ) defined by ISO.

Different optical parameters for the examples in FIGS. 3 to 5 are summarized in the following table:

TABLE 1

| Example: | FIG. 3 | FIG. 4 | FIG. 5 |
|---|---|---|---|
| Total reflection Rt in %, | 2.16 | 1.23 | 1.59 |
| weighted by sensitivity | | | |
| Minimum total reflection in %, | 1.28 | 1.16 | 1.11 |
| over the range 400-800 nm | | | |
| Wavelength in nm, for | 785 | 610 | 320 |
| minimum total reflection | | | |
| Diffuse reflection Rd in %, | 1.84 | 0.66 | 0.35 |
| weighted by sensitivity | | | |
| Percentage ratio, between Rd | 85.2 | 53.7 | 22 |
| and Rt | | | |

The reflection value Rt on an outer surface of an untreated and untextured glass substrate is usually of the order of 8%. The Rd/Rt ratio for the same untreated and untextured glass substrate would usually be of the order of 1%.

As illustrated in FIG. 7, texturing the two glass surfaces according to the examples in FIGS. 3 to 5 provides a relatively high and fairly constant optical transmission, particularly over the range of human spectral sensitivity.

According to the intended use of the scattering and conductive anti-reflective surface, criteria on optical and/or electrical properties could be imposed. These properties depend on the texturing applied to the dielectric substrate as well as the thickness of the conductive layer.

FIG. 6 illustrates the structures obtained after TCO deposition on one of the textured surfaces of the substrate 2. Regardless of the thickness of TCO deposited, the structures obtained have a rounded dome shape. The appearance of the structures is in accordance with the shape of the glass texturing carried out before ITZO deposition. This is related to the deposition process, which induces growth on the texturing peaks, thus generating porosity in the ITZO layer. The detail of the structure obtained for a thickness of 150 nm shows a variation in the deposition thickness according to the position on the structure: around 150 nm on peaks and less than 25 nm in recesses and walls.

FIGS. 10 to 13 illustrate the evolution of the different electrical and optical properties of surfaces with scattering and conductive anti-reflective properties for different thicknesses of ITZO conductive layers.

The diagram in FIG. 10 compares the resistance per square of a transparent electrode in the case of deposition on a smooth glass substrate (diamonds) and in the case of deposition on a textured glass substrate (squares) corresponding to the example in FIG. 3, as a function of the thickness Ep of this electrode. In the case of the invention, there is an exponential decrease in resistance per square as a function of thickness, the decrease in resistance per square according to the prior art being linear. There is also a higher resistance per square with a textured glass substrate compared with a smooth substrate, for thin electrodes. There is also a much closer resistance per square between a textured glass substrate compared with a smooth substrate, for thicker electrodes.

FIGS. 11 and 12 illustrate the influence of the thickness Ep of the electrode 3 on the total and diffuse reflection optical properties of the scattering and conductive anti-reflective surface. As illustrated in the diagram in FIG. 11, the thickness Ep of an electrode on a smooth glass substrate of the prior art strongly affects the total optical reflection Rt, both on the oscillations created by interference and on the average. The diagram in FIG. 12 illustrates the small influence of the electrode thickness Ep on the total optical reflection Rt for a deposition on a textured glass substrate corresponding to the example in FIG. 3. The diagram in FIG. 13 illustrates the diffuse optical reflection Rd for different thicknesses Ep of the electrode 3 deposited on a textured substrate corresponding to the example in FIG. 3, as a function of wavelength. There is a very small influence of the thickness of the electrode 3 on diffuse optical reflection. In addition, the proportion of this diffuse optical reflection in relation to the total optical reflection was at least 40%, whereas this proportion is close to 0 for an electrode on a smooth substrate. Therefore, the thickness of the electrode 3 does not affect the corresponding anti-glare properties. The solid line curve corresponds to the human spectral sensitivity Sens, according to the function V(λ) defined by ISO.

The diagram in FIG. 14 helps to better illustrate the a priori very small influence of the thickness of the electrode 3 on the reflection or the diffuse Rd/Rt ratio at the interface 23. On the other hand, the thickness of the electrode 3 has a strong influence on its resistance per square R/sq.

Therefore, an electrode 3 according to the invention may have a significant thickness to promote a reduced resistance per square, without increasing optical reflection. It can also be noted that the texturing configuration of the surface 22 of the substrate 2 is the main parameter for defining the total optical reflection at the interface 23 or the interface 20.

The process for fabricating a scattering and conductive anti-reflective surface according to the invention may involve specific steps of texturing the surfaces 21 and 22 of the glass substrate 2.

In order to have a simple and inexpensive fabrication process, the texturing of the surfaces 21 and 22 of the glass substrate 2 is advantageously carried out with no specific masking step (e.g. particle spreading or photolithography) and with the same etching technology. Advantageously, the texturing of the surfaces 21 and 22 is carried out by dry etching of the plasma vacuum type. Such etching notably allows texturing to be carried out without exceeding the glass transition temperature of the glass. Advantageously, such etching is carried out for a maximum of 30 minutes.

Experimental results determined that etching parameters such as pressure, gas mixture type, polarization voltage and etching time made it possible to modify the roughness parameters of the etched surface. The roughness parameters of the etched surface can thus be modified, such as relief pitch, relief height, relief width and/or relief height/width ratio.

Experiments were thus notably carried out with the following plasma etching parameters on alumino-borosilicate type glasses (in particular glass marketed as Corning Eagle XG):
a CHF₃/O₂ gas mixture with a mixing ratio of between 10 and 15;
a working pressure of between 50 and 200 mTorr;
a radiofrequency power density of between 1.65 and 3.56 W/cm²;
an etching time of between 7 and 60 min;
a process temperature of 18° C.

In the example illustrated in FIG. 3, the etching parameters used are as follows:
a CHF₃/O₂ mixing ratio of 10;
a working pressure of 200 mTorr;
a power density of 3.56 W/cm²;
a processing time of 30 minutes.

In the example illustrated in FIG. 4, the etching parameters used are as follows:
a CHF₃/O₂ mixing ratio of 12;
a working pressure of 100 mTorr;
a power density of 2.45 W/cm²;
a treatment time of 20 minutes.

In the example illustrated in FIG. 5, the etching parameters used are as follows:
a CHF₃/O₂ mixing ratio of 15;
a working pressure of 50 mTorr;
a power density of 1.65 W/cm²;
a treatment time of 10 minutes.

The process for fabricating the device 1 can implement specific steps to deposit the electrode 3 after the texturing of the surface 22. The electrode 3 can be formed, for example, by magnetron sputtering of a transparent conductive film onto the textured surface 22. The electrode material 3 can be known per se, for example a doped zinc oxide, a doped tin oxide, or a doped indium oxide.

With a deposition of an electrode 3 with an average thickness less than the texturing depth of the surface 22, the experiments showed that a non-uniform thickness of the electrode 3 could be obtained, according to the magnified section schematically illustrated in FIG. 1. As illustrated here, the reliefs of the surface 32 of the electrode 3 are superposed on the reliefs of the surface 22. The electrode 3 has zones 36 superposed on the reliefs of the surface 22, and zones 35 superposed on the bottom of the surface 22. In the zones 36, the electrode 3 has a greater thickness than in the zones 35. As illustrated, this non-uniform thickness is obtained while guaranteeing the continuity of the electrode 3.

Advantageously, the electrode 3 deposited must guarantee a resistance per square at most equal to 100 Ω/square. Such a resistance of the electrode 3 makes it possible to optimally collect the electrical charges generated at the device 4.

Advantageously, the deposited electrode 3 must have a minimum optical reflection over a wavelength range centred around 550 nm.

1. Scattering and conductive anti-reflective surface, characterized in that it comprises a continuous electrically conductive material of variable thickness deposited on a textured surface so as to render the assembly anti-reflective and scattering, the surface comprising a surface structure of a material and an electrically conductive deposit whose texture is anisotropic in the plane, the texture forming valleys whose length is greater than the width and separated by walls of triangular section.

2. Scattering and conductive anti-reflective surface according to claim 1, wherein the shape ratio of the structure is greater than 0.5.

3. Scattering and conductive anti-reflective surface according to claim 2, wherein the electrically conductive material has a thickness at most equal to a depth of the texturing.

4. Scattering and conductive anti-reflective surface according to claim 1, wherein the electrically conductive material has a thickness of at least 120 nm.

5. Scattering and conductive anti-reflective surface according to claim 1, wherein the electrically conductive material has a thickness of at least 25% of the depth of the texturing.

6. Scattering and conductive anti-reflective surface according to claim 1, wherein the texturing reliefs of the contact interface are superposed on the texturing reliefs of the second surface.

7. Scattering and conductive anti-reflective surface according to claim 6, wherein the thickness of the electrically conductive material is greater at the peaks of the texturing reliefs relative to its thickness at the bottom of the texturing.

8. Scattering and conductive anti-reflective surface according to claim 1, wherein the electrically conductive material is made of a material selected from the group consisting of doped zinc oxide, doped tin oxide, doped indium oxide and alloys thereof, or carbonaceous materials such as carbon nanotubes or graphene or thin metal layers of Ag, Al, Cu, Au or nanotubes of conductive materials such as silver or a combination these materials.

9. Optical device comprising at least one scattering and conductive anti-reflective surface according to claim 1.

10. Process for fabricating a scattering and conductive anti-reflective surface, comprising the steps of:
texturing a first surface by plasma etching of a transparent substrate such as glass so that this first surface effectively transmits light with an essentially diffuse residual reflection rate;
texturing a second surface by plasma etching of the substrate;
depositing a transparent conductive layer on the second surface of the substrate so as to form an electrode having a first surface in contact with the second surface of the substrate, and a second surface opposite the first surface of the electrode, so that the second surface retains at least part of the texturing of the second surface of the substrate, the electrical conductive deposition having anisotropic texturing in the plane, the texturing forming valleys whose length is greater than the width and separated by walls of triangular section.

11. Process for fabricating a scattering and conductive anti-reflective surface according to claim 10, wherein said texturing steps are carried out without masking the surfaces of the substrate prior to etching the structures.

12. Process for fabricating a scattering and conductive anti-reflective surface according to claim 1, wherein the thickness of the deposited transparent conductive layer is at most equal to the texturing depth of the second surface of the substrate.

13. Process for fabricating a scattering and conductive anti-reflective surface according to claim 1, wherein the thickness of the deposited transparent conductive layer is greater at the peaks of the texturing reliefs of the second surface of the substrate relative to its thickness at the bottom of the texturing of the second surface of the substrate.
